(19) United States
(12) Patent Application Publication
(10) Pub. No.: US 2009/0116042 A1
(43) Pub. Date: May 7, 2009

(54) Image-forming apparatus

(75) Inventor: Ryosuke Ohgishi, Tokyo (JP)

Correspondence Address: FITCH, EVEN, TABIN & FLANNERY, P. O. BOX 18415, WASHINGTON, DC, 20036, US

(73) Assignee: Kyocera Mita Corporation, Osaka (JP)

(21) Appl. No.: 12/260,496

(22) Filed: Oct. 29, 2008

(30) Foreign Application Priority Data
Nov. 7, 2007 (JP) 2007-289380

(51) Int. Cl. G06F 3/12

(52) U.S. Cl. 358/1.2

(57) ABSTRACT

An image forming apparatus includes a display panel that provides a display including at least one apparatus setting, a panel image recording unit that records at least a portion of an image displayed on the display panel to provide a recorded image, and a printing unit that prints the recorded image.

### BACKGROUND OF THE INVENTION

1. Field of the Invention

The present invention relates to a technology enabling the printing of an image displayed on a display panel in an image forming apparatus.

2. Description of the Related Art

In order to check set values, such as an Internet Protocol (IP) address and Domain Name System (DNS) information, when using an image forming apparatus such as a copying machine, there is a known method of visually checking the set contents using an operation panel and a utility. There is also a known method of displaying printing results on a preview screen and displaying or printing hand-entered inputs to the preview screen. In these known methods, set contents are displayed on an operation panel or a display so that a user can check the set contents.

### SUMMARY OF THE INVENTION

It is an object of the present invention to provide an image forming apparatus in which a screen of an operation panel is directly printed.

An image forming apparatus according to an aspect of the present invention comprises: a display panel that provides a display including at least one apparatus setting, a panel image recording unit that records at least a portion of an image displayed on the display panel to provide a recorded image, and a printing unit that prints the recorded image.

Still other objects of the present invention and specific advantages obtained from the present invention are clarified further from embodiments described below.

In this text, the terms “comprising”, “comprise”, “comprises”, and other forms of the word “comprise” can have the meaning ascribed to these terms in U.S. Patent Law and can mean “including”, “include”, “includes”, and other forms of the term “include”.

### BRIEF DESCRIPTION OF THE DRAWINGS

In the accompanying drawings:

FIG. 1 is a functional block diagram of an image forming apparatus of an embodiment according to the present invention;

FIG. 2 is a diagram illustrating an exemplary display of a display panel of the image forming apparatus of the embodiment according to the present invention; and

FIG. 3 is a plan view of an operation panel unit of the image forming apparatus of the embodiment according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common, well-understood elements that are useful or necessary in a commercially feasible embodiment are often not depicted in order to facilitate a less obstructed view of various embodiments of the present invention. It will further be appreciated that certain actions and/or steps may be described or depicted in a particular order of occurrence, while those skilled in the art will understand that such specificity with respect to sequence is not actually required. It will also be understood that the terms and expressions used herein have the ordinary technical meaning accorded to such terms and expressions by persons skilled in the technical field as set forth above, except where different specific meanings are otherwise set forth herein.

### DETAILED DESCRIPTION OF THE PREFERRED EMBODIMENTS

Pursuant to these teachings, an image forming apparatus comprises a display panel that provides a display including at least one apparatus setting, a panel image recording unit that records at least a portion of an image displayed on the display panel to provide a record image, and a printing unit that prints the recorded image. Therefore, for example, when a network address is checked, and when information is desired to be checked by carrying a preview screen of a document box, the screen of the display panel can be printed easily as it is, instead of information customized by a manufacturer such as a status page, thereby enhancing the convenience of a user.

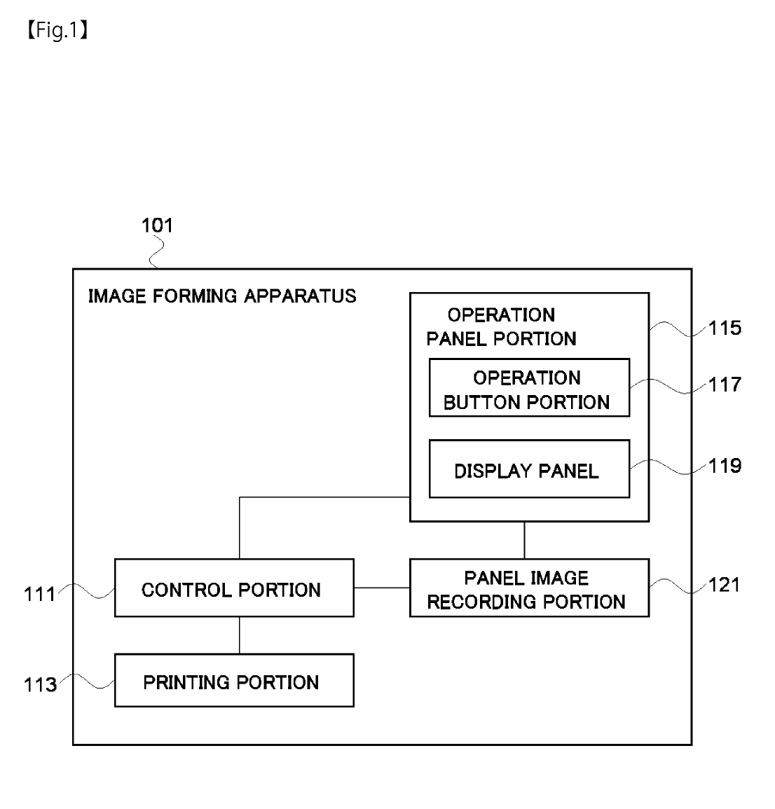

Referring now particularly to the drawings, FIG. 1 is a functional block diagram of an embodiment of an image forming apparatus according to the present invention.

The image forming apparatus 101 has at least respective functional blocks of a control unit 111, a printing unit 113, an operation panel unit 115, an operation button unit 117, a display panel 119, and a panel image recording unit 121.

The control unit 111 performs control of the entire image forming apparatus 101 and transfer of a file of an image of a display panel recorded by the panel image recording unit 121. A file may be recorded in a file box in the image forming apparatus 101 or may be transferred to another image forming apparatus or a server apparatus connected via a network.

The printing unit 113 is a functional unit of the image forming apparatus 101 that provides and affects the printing function. The printing unit 113 performs ordinary printing, or printing for copying or facsimile reception, and, additionally, performs printing of an image of the display panel 119 recorded by the panel image recording unit 121.

The operation panel unit 115 includes the operation button unit 117 and the display panel 119. The operation of the image forming apparatus 101 can be performed by using this operation panel unit 115. A more detailed description in this regard is described below.

The operation button unit 117 is a button placed on the operation panel unit 115. This operation button unit 117 facilitates the selection of each end-user enabled function of the image forming apparatus 101 such as copying, printing, scanning, and telecopying, as well as setting the number of copies to be made and designating the execution of copying.

The display panel 119 is a panel which displays a setting state and an operation state of the image forming apparatus 101, and a touch-panel mechanism is placed on the surface thereof. The display panel 119 allows the touch-panel mechanism to detect the contact of an end-user's finger or the like onto a button displayed on the display panel 119, and to responsively then facilitate the performance of the corresponding function of the button.

The panel image recording unit 121 records a bit map of image information displayed on the display panel 119 and, in the case where a display on the display panel is an image described by a Hyper Text Markup Language (HTML), the panel image recording unit 121 records and saves an HTML file. The saved image information can be transferred to the printing unit 113 to be printed, recorded in a file box (for example, a document box) in the image forming apparatus 101, and/or transferred to an external apparatus.

Regarding the description of the functional blocks, the description of well-known portions that are not related to the nature of the present invention, such as a scanner unit and a network interface provided in an ordinary image forming apparatus, are omitted for the sake of clarity.

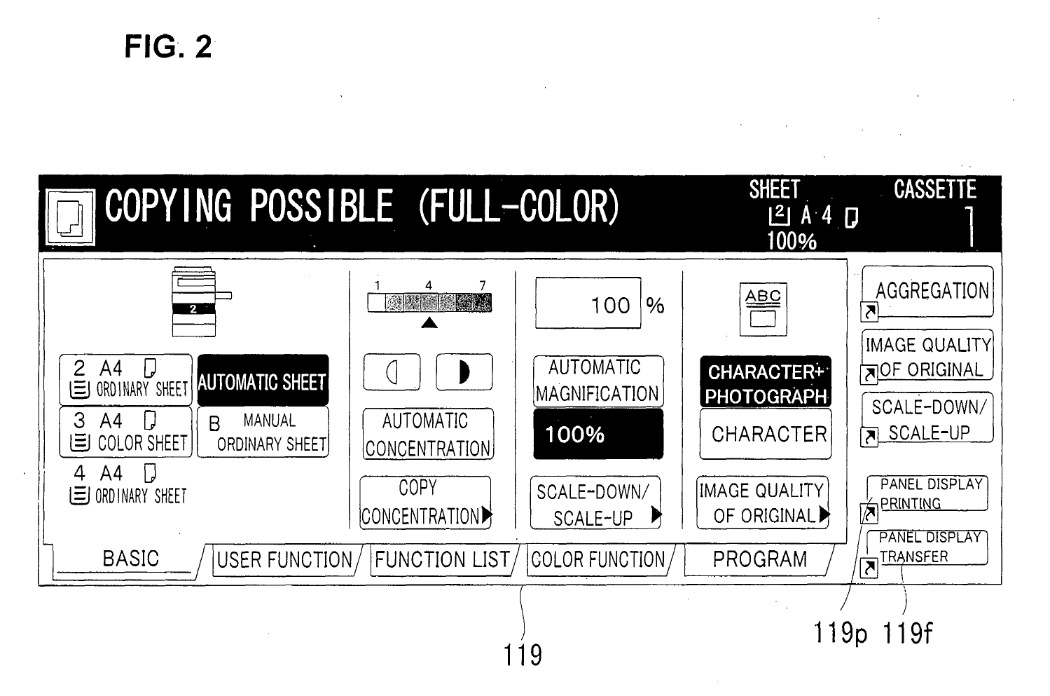

FIG. 2 shows an example of an operation screen displayed on the display panel 119. Those skilled in the art will recognize and understand that this example is intended to serve only in an illustrative capacity and is not intended to comprise an exhaustive listing of all possibilities in this regard.

FIG. 2 illustrates a setting screen regarding a basic operation of the image forming apparatus 101. A panel display printing button 119p (instruction button) and a panel display transfer button 119f (instruction button) are placed in a lower right end portion of the screen. When the control unit 111 receives an input via the panel display printing button 119p, the control unit 111 instructs the printing unit 113 to print image information displayed on the display panel 119. That is, when the panel display printing button 119p is pressed, the image information that is currently being displayed on the display panel 119 is printed by the printing unit 113.

When the control unit 111 receives an input via the panel display transfer button 119f, the control panel 111 transfers the image information displayed on the display panel 119 to a set file storage destination (within, for example, the image forming apparatus 101, another image forming apparatus, an external server apparatus, or the like). That is, the image information that is currently being displayed on the display panel 119 is transferred to the set file storage destination (the image forming apparatus 101, another image forming apparatus, the external server apparatus, or the like) by pressing the panel display transfer button 119f. Those skilled in the art will recognize that such a transfer can comprise a transfer of the complete original image information or can comprise a transfer of a compressed version thereof.

The above printing or file transfer can be performed by previously setting whether to include the images of the panel display printing button 119p and the panel display transfer button 119f displayed on the display panel or by providing an instruction by a corresponding selection in a dialog box regarding whether the images of the panel display printing button 119p and the panel display transfer button 119f displayed on the display panel are to be so included after pressing the above buttons.

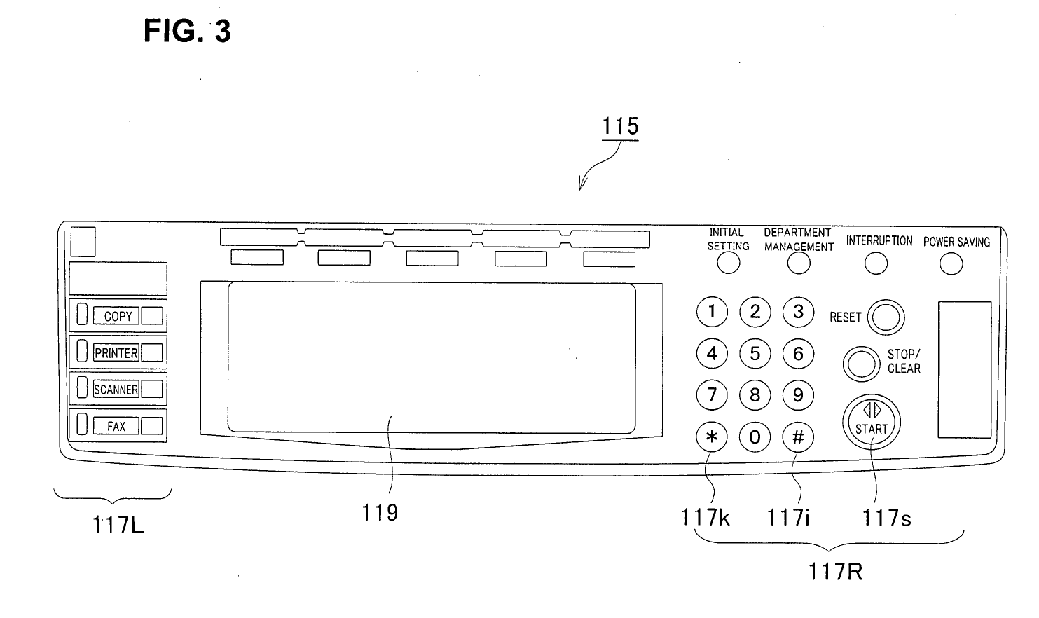

FIG. 3 shows an entire view of the operation panel unit 115. The display panel 119 is placed at the center of the operation panel unit 115 (display is omitted), and a function selecting button 117L for selecting the function of the image forming apparatus is placed on the left side of the display panel 119. In addition, setting buttons 117R to use when entering one or more apparatus settings (including a ten-key button, a start button and other buttons as desired) are placed on the right side of the display panel 119.

Printing and file transfers of a panel display can also be performed with an operation button of the image forming apparatus without using (that is, without displaying) the panel display printing button 119p and the panel display transfer button 119f on the display panel used in FIG. 2.

For example, an instruction of file printing could be

provided as follows: A pound sign (or hash mark) “#” button 117i (one of a plurality of buttons) and a “start” button 117s (one of a plurality of buttons) are pressed simultaneously, whereby the image information that is being displayed at that time on the display panel 119 is sent to the printing unit for printing.

Similarly, an instruction to facilitate a file transfer could be performed as follows: An asterisk “*” button 117k (one of a plurality of buttons) and the “start” button 117s (one of a plurality of buttons) are pressed simultaneously, whereby the image information that is being displayed at that time on the display panel 119 is transferred to the image forming apparatus 101, another image forming apparatus, or the external server apparatus by the control unit 111 as suggested above.

The image forming apparatus described herein enables an image on a display panel to be printed as it is or transferred as a file. Information settings for the image forming apparatus (for example, the IP address and the DNS information) that are printed and/or transferred as a record in this manner can be held or saved as an archival record as desired. Therefore, such information can be used as a memorandum for checking the operation of the image forming apparatus or used as a record for maintenance, thereby enhancing convenience.

When uncertainty occurs during operation of the image forming apparatus, a display panel screen can be printed at that time, and the printed matter can be faxed, for example, to a support center to resolve the uncertainty. This can greatly facilitate the smooth, expeditious solution of the problem.

The embodiments presented above can be generally summarized as follows: An image forming apparatus comprises a display panel that provides a display including at least one apparatus setting, a panel image recording unit that records at least a portion of an image displayed on the display panel to provide a recorded image, and a printing unit that prints the recorded image.

The image forming apparatus may also comprise a control unit that performs a file transfer of the recorded image.

In addition, the image forming apparatus may comprise an operation button that is used to perform the at least one apparatus setting, and a control unit that provides an instruction to print the recorded image when receiving an input via the operation button.

The control unit may provide the instruction to print the recoded image when receiving simultaneous inputs via a plurality of the operation buttons.

The control unit may also provide at least one of the instruction to print the recorded image and an instruction to effect the file transfer of the recorded image when receiving an input via the operation button.

In addition, the control unit may provide at least one of the instruction to print the recorded image and the instruction to effect the file transfer of the recorded image when receiving simultaneous inputs via the operation buttons.

The display panel is configured to display an instruction button that is used to perform the at least one apparatus setting, and the display panel has a touch-panel mechanism that detects selection of the instruction button, the instruction button being used to provide an instruction to print the recorded image.

When the printing of the recorded image is performed, an image of the instruction button displayed on the display panel is excluded in the printing of the recorded image.

The display panel is configured to display an instruction button that is used to perform the at least one apparatus setting, and the display panel has a touch-panel mechanism that detects selection of the instruction button, the instruction button being used to perform at least one of instructing the printing of the recorded image and instructing the file transfer of the recorded image.

When performing at least one of the printing of the recorded image and the file transfer of the recorded image, an image of the instruction button displayed on the display panel is excluded in the image as printed or transferred.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. An image forming apparatus, comprising:
a display panel that provides a display including at least one apparatus setting;
a panel image recording unit that records at least a portion of an image displayed on the display panel to provide a recorded image; and
a printing unit that prints the recorded image.

2. The image forming apparatus according to claim 1, further comprising a control unit that performs a file transfer of the recorded image.

3. The image forming apparatus according to claim 1, further comprising an operation button that is used to perform the at least one apparatus setting and a control unit that provides an instruction to print the recorded image when receiving an input via the operation button.

4. The image forming apparatus according to claim 3, wherein the control unit provides the instruction to print the recorded image when receiving simultaneous inputs via a plurality of operation buttons.

5. The image forming apparatus according to claim 2, further comprising an operation button that is used to perform the at least one apparatus setting, wherein the control unit provides at least one of an instruction to print the recorded image and an instruction to effect a file transfer of the recorded image when receiving an input via the operation button.

6. The image forming apparatus according to claim 5, wherein the control unit provides at least one of the instruction to print the recorded image and the instruction to effect a file transfer of the recorded image when receiving simultaneous inputs via a plurality of operation buttons.

7. The image forming apparatus according to claim 1, wherein the display panel is configured to display an instruction button that is used to perform the at least one apparatus setting, and the display panel has a touch-panel mechanism that detects selection of the instruction button, the instruction button being used to provide an instruction to print the recorded image.

8. The image forming apparatus according to claim 7, wherein, when printing of the recorded image is performed, an image of the instruction button displayed on the display panel is excluded in the printing of the recorded image.

9. The image forming apparatus according to claim 2, wherein the display panel is configured to display an instruction button that is used to perform the at least one apparatus setting, and the display panel has a touch-panel mechanism that detects selection of the instruction button, the instruction button being used to perform at least one of instructing the printing of the recorded image and instructing the file transfer of the recorded image.

10. The image forming apparatus according to claim 9, wherein, when at least one of the printing of the recorded image and the file transfer of the recorded image is performed, an image of the instruction button displayed on the display panel is excluded in the image as printed or transferred.
